(19) United States
(12) Patent Application Publication
(10) Pub. No.: US 2006/0237290 A1
(43) Pub. Date: Oct. 26, 2006

(54) Device for retaining a headed pivot rod

(76) Inventors: Dieter Guldenfels, Pfeffingen (CH); Paul E. Hirschmann, 475 Big Bend Trail, GA (US); Michael Anthony Peach, 6190 Broadwater Trail, GA (US)

Correspondence Address: HODGSON RUSS LLP, ONE M & T PLAZA, SUITE 2000, BUFFALO, NY, 14203-2391, US

(21) Appl. No.: 10/567,634

(22) PCT Filed: Aug. 12, 2004
(86) PCT No.: PCT/US04/26468

§ 371 Date: Feb. 8, 2006

Related U.S. Application Data
(60) Provisional application No. 60/494,378, filed on Aug. 12, 2003.

(51) Int. Cl. B65G 17/06

(52) U.S. Cl. 198/853

(57) ABSTRACT

A belt module (10), modular belt assembly and method of configuring a modular belt to provide an edge portion for retaining a headed pivot rod (103). The edge portion has a blocking member (70) disposed in a slot (73) and movable between a first open position and a second closed position. In, the closed position, the blocking member extends into an edge portion pivot rod opening (51) to prevent the headed pivot rod from exiting the edge portion pivot rod opening. The edge portion pivot rod opening is larger than the first and second pivot rod openings in the first and second link ends of the belt module such that the pivot rod can only be removed in one direction.

### CROSS-REFERENCE TO RELATED APPLICATION

The present application claims priority to U.S. Provisional Patent Application No. 60/494,378 filed on Aug. 12, 2003, and entitled “Device for Retaining a Headed Pivot Rod,” which is incorporated herein by reference.

### FIELD OF INVENTION

The present invention relates to conveyor belts, particularly plastic modular conveyor belts used primarily in the food industry.

### BACKGROUND OF THE INVENTION

Because they do not corrode, are lightweight, and are easy to clean, unlike metal conveyor belts, plastic conveyor belts are used widely, especially in material handling conveying food products. Modular plastic conveyor belts are made up of molded plastic modular links, or belt modules, that can be arranged side by side in rows of selectable width. A series of spaced apart link ends extending from each side of the modules include aligned apertures to accommodate a pivot rod. The link ends along one end of a row of modules are interconnected with the link ends of an adjacent row. A pivot rod journaled in the aligned apertures of the side-by-side and end-to-end connected modules forms a hinge between adjacent rows. Rows of belt modules are then connected together to form an endless conveyor belt capable of articulating about a drive sprocket.

The retention of the pivot rod is an important feature of the modular plastic conveyor belts. Rod retention can be accomplished by enlarging the heads of the pivot rods at both ends but such would not allow for disassembly without destroying the rod head. Headless rods have been used for easier production and belt assembly. These type of rods must be blocked at both ends of the belt during use. Typically one outside module is provided with a special module having a closed end aligned with the pivot rod, and the opposite outside module is provided with a shuttle or plug-type lock for blocking the aligned apertures to prevent egress of the pivot rod. Alternatively, both edge modules may be provided with the shuttle or plug-type locks described above. Such shuttle or plug-type locks are often favored for easy installation and removal of the pivot rods. But access to both belt edges is necessary to open/close the shuttle/plug and push out/extract the rod. The need for access to both sides increases the risk of the shuttle not being closed properly and makes inspection difficult.

What is needed is a rod retaining device that only requires a special module at one edge and for which insertion and removal of the pivot rod can be carried out from one edge only.

### SUMMARY OF THE INVENTION

The present invention meets the above-described need by providing a pivot rod retaining device suitable for use with a pivot rod having a head.

### BRIEF DESCRIPTION OF THE DRAWINGS

The invention is illustrated in the drawings in which like reference characters designate the same or similar parts throughout the figures of which:

FIG. 1 is a top plan view of a belt formed from belt modules of the present invention and including a partial cut-away section;

FIG. 2 is an end view of one of the modules shown in FIG. 1;

FIG. 3 is a cross-sectional view taken along lines 3-3 of FIG. 1;

FIG. 4 is a sectional end view with the lock in the closed position;

FIG. 4A is a partial sectional end view of an alternate embodiment of the module shown in FIG. 4;

FIG. 5 is a cross-sectional view taken along lines 5-5 of FIG. 4;

FIG. 5A is a bottom view of a module having a slot for access to the pivot rod;

FIG. 6 is a sectional view of the lock in the open position;

FIG. 7 is a side elevation view of a first embodiment of the shuttle of the present invention;

FIG. 8 is a top view of the shuttle shown in FIG. 7;

FIG. 9 is a sectional side view of a second embodiment of the shuttle with the lock shown in the closed position; and,

FIG. 10 is a top plan view of a bricklayed belt of the present invention.

### DETAILED DESCRIPTION

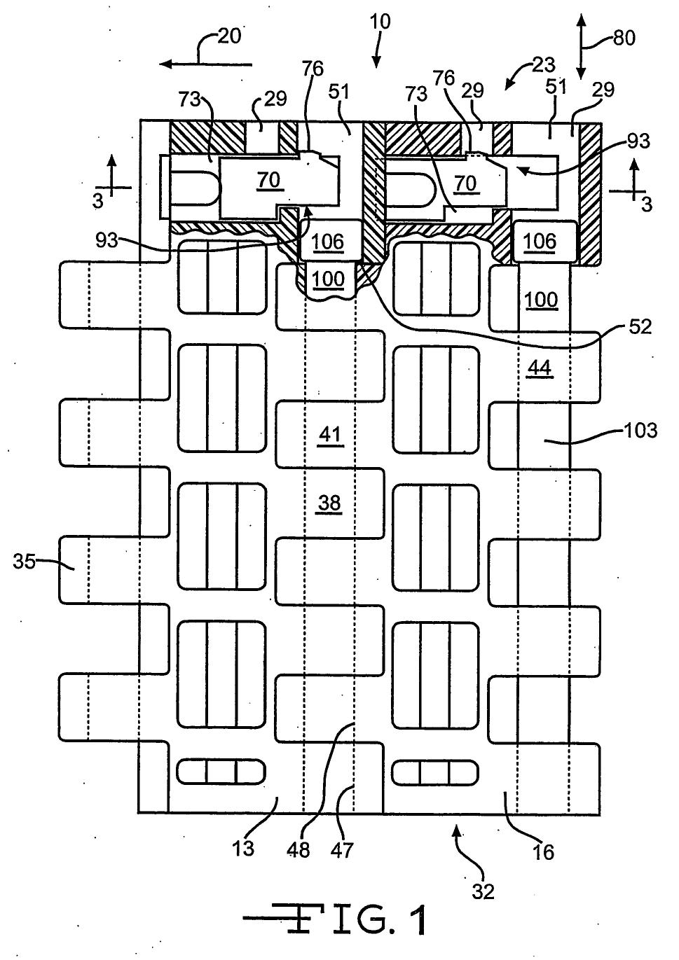

In FIG. 1, a modular conveying belt 10 is formed from the juxtaposition of belt modules 13 and 16. For reference purposes, the direction of belt travel is indicated by arrow 20, however, the belt 10 of the present invention may also travel in the opposite direction. The belt modules 13 and 16 are preferably manufactured from plastic or other materials suitable for use in conveying food items. The plastic modules may be thermoformed through a plastic molding process as will be evident to those of ordinary skill in the art. Plastic belts are relatively inexpensive, easy to clean and durable. Also, because they do not corrode and are light-weight, they are used widely, especially in material handling and conveying food products. The modules 13 and 16 shown in FIG. 1 are arranged in end-to-end fashion to form the belt 10. The edge 23 at the top of FIG. 1 is provided with a lock and an opening 29 which will be described in greater detail herein. The modules 13 and 16 are designed specifically for placement at one of the outer edges of the belt 10. The opposite edge 32 has a standard configuration as will be described below. Accordingly, standard modules can be placed alongside modules 13, 16 to form belts 10 of varying widths in bricklayed fashion.

With reference to the orientation of FIG. 1, a plurality of first link ends 35 are disposed on the left hand side of module 13 and a plurality of second link ends 38 are disposed on the right hand side of module 13. Similarly, module 16 also includes a plurality of first link ends 41 and a plurality of second link ends 44.

With reference to module 13, the second link ends 38 have a plurality of first journaling apertures 47 defined therein. The apertures 47 are sized to receive the body portion 100 of pivot rods 103. Specifically, the apertures 47 are slightly larger than the diameter of the body portion 100. The first apertures 47 are capable of aligning with similar journaling apertures 48 in the first plurality of link ends 41 disposed on the adjacent module 16. As shown in the cut-away section of FIG. 1, module 13 has an enlarged opening 51 sized to receive a head portion 106 of a pivot rod 103. Apertures 47 and 48 are smaller in diameter than the diameter of the head portion 106. As shown, the enlarged opening 51 is larger than apertures 48 of the adjacent module such that when the modules 13 and 16 are intercalated a ledge 52 is created and the pivot rod 103 is obstructed by the smaller aperture 47. Accordingly, the pivot rod 103 cannot pass through the belt 10 in the direction from edge 23 to edge 32. As a result, the link ends disposed at edge 32 do not have to be made special with closed ends or additional locks to prevent the pivot rod 103 from exiting the belt 10.

Returning to the top of the figure, the pivot rod 103 is accessible only from the top edge 23 of belt 10 for insertion and removal. A blocking member 70 is disposed in a cavity 73 formed inside each module 13, 16. The blocking member 70 is shown in the open position in module 16 and in the closed position in module 13.

As will be evident to those of ordinary skill in the art, the blocking member 70 may be installed in numerous ways including, but not limited, to the arrangements disclosed in U.S. Pat. Nos. 5,904,241 and 5,217,110 which are incorporated herein by reference.

The cavity 73 provides a pathway oriented substantially transverse to axis 80 defined in the longitudinal direction of the pivot rods 103. The blocking member 70 has a detent 76 that engages with the wall surrounding opening 29 in the open position. In the closed position (shown on the left hand side with respect to the orientation of FIG. 1), the detent 76 engages with the wall surrounding an opening 93. Opening 93 extends to and intersects with enlarged opening 51.

As shown in module 13, the blocking member 70 blocks the enlarged opening 51 to prevent the pivot rod 103 from exiting the module. The blocking member 70 extends across at least 30-50% of the diameter of the enlarged opening 51.

Turning to FIG. 2, the blocking member 70 is shown in the closed position where it obstructs opening 51. The end of the module 13 includes an opening 80 that provides access to the blocking member 70 for moving it between the open and closed position.

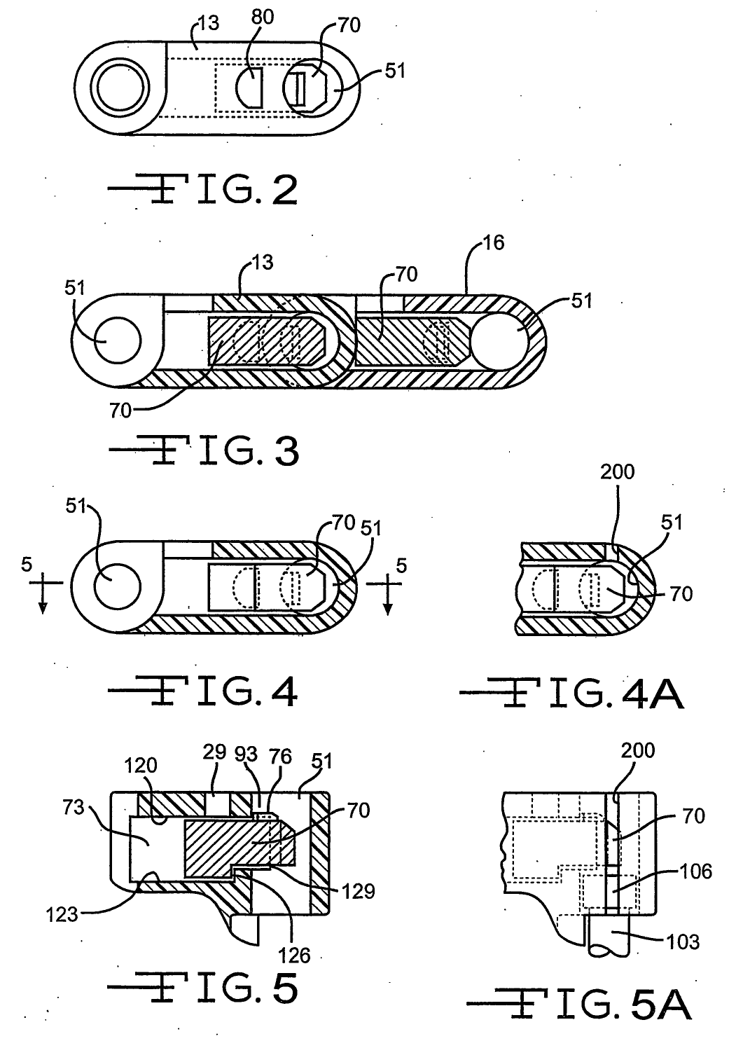

In FIG. 3, a cross-sectional view shows the blocking member 70 in the open position on the right hand side of the figure and shows the blocking member 70 in the closed position on the left hand side of the figure. As shown, the blocking member 70 moves substantially perpendicular to the longitudinal axis of the pivot rod 103. When the blocking member 70 is shifted into the position on the left where it obstructs the enlarged opening 51, the head 106 of the pivot rod 103 is captured between the blocking member 70 and the ledge 52 (best shown in FIG. 1). As a result, rod retention and rod removal are accomplished from one side of the belt 10. The modules that are bricklayed from the opposite end 32 of modules 13 and 16 may be of standard construction without any apparatus such as closed ends or additional locks for rod retention.

In FIG. 4, the blocking member 70 is shown from the end in its closed position where it extends into the enlarged opening 51 to obstruct the head of the pivot rod such that the pivot rod is prevented from exiting from the enlarged opening 51.

In FIG. 5, the cavity 73 is shown in greater detail. The cavity includes upper and lower surfaces 120 and 123. The lower surface 123 may be stepped with a vertical wall 126 and a horizontal wall 129 to provide a mechanical stop to hold the blocking member in the closed position. As shown, when the blocking member 70 is in the closed position, the detent 76 engages with the wall surrounding the opening 93 and the blocking member 70 engages with the vertical wall 126. As shown, the blocking member 70 may be formed in an L-shape to provide a cooperating surface to engage with the wall 126.

As shown in FIGS. 4A and 5A, the modules 13, 16 may be provided with a slot 200. The slot 200 provides access to head portion 106 of pivot rod 103. A screw driver (not shown) or the like can be inserted through the slot 200 to engage the head of the pivot rod 103 to push it out of the bore.

Turning to FIG. 6, when the blocking member 70 is in the open position the detent 76 is held in position between the walls surrounding the opening 29.

Referring to FIGS. 7-8, the blocking member 70 may be formed in an L-shape with a vertical portion 74 forming a ledge between surfaces 200 and 203. Detent 76 may be provided with a chamfered edge 77 to provide for moving it between the open and closed positions for insertion and removal of the pivot rod 103.

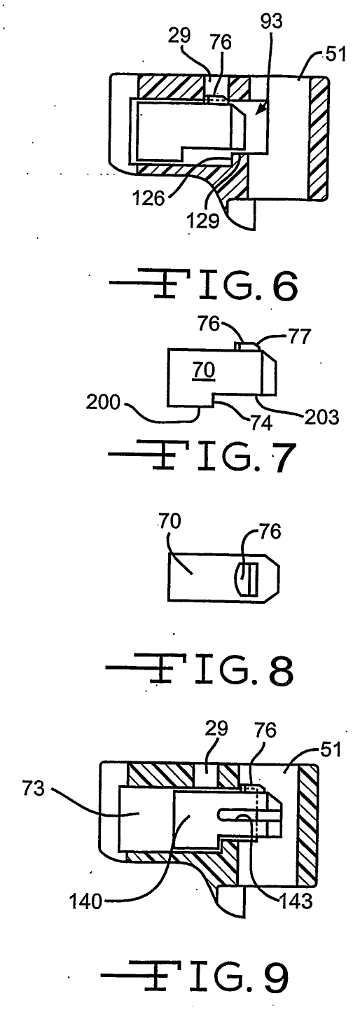

In an alternate embodiment shown in FIG. 9, a blocking member 140 has a slot 143 formed therein. The slot 143 provides the blocking member 140 with additional flexibility such that member is capable of compressing to facilitate passing the detent member 76 from the open to the closed position and vice versa.

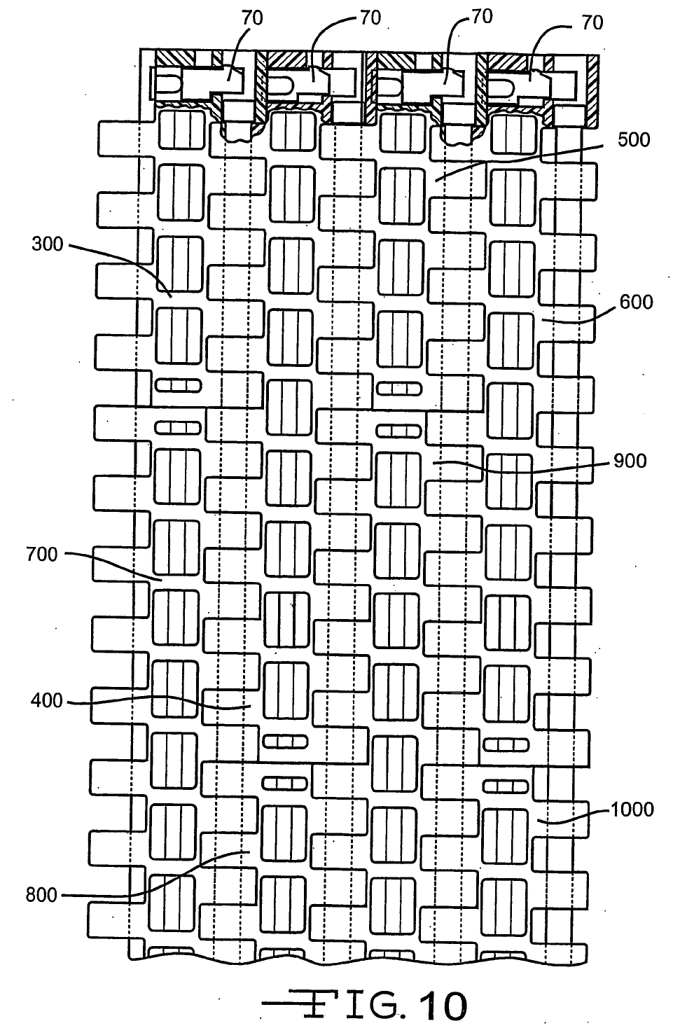

Turning to FIG. 10, it will be evident to those of ordinary skill in the art that belt modules 300, 400, 500, 600, 700, 800, 900, and 1000 of the present invention may be arranged in bricklayed fashion as shown. Outer modules 300, 400, 500, and 600 include blocking member 70. Inside modules 700, 800, 900, and 1000 may be of conventional construction with typical pivot rod openings at opposite ends.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A belt module for use with a headed pivot rod, the belt module, comprising:
a first plurality of link ends disposed in a direction of belt travel, the first link ends having first pivot rod openings disposed transverse to the direction of belt travel;
a second plurality of link ends extending in a direction opposite to the first plurality of link ends, the second link ends being offset from the first link ends such that adjacently positioned belt modules are capable of intercalating so that the first link ends of one belt module fit into spaces defined between the second plurality of link ends of an adjacent belt module, the second link ends having second pivot rod openings disposed transverse to the direction of belt travel;
an edge portion having an edge portion pivot rod opening disposed transverse to the direction of belt travel, the edge portion pivot rod opening having a diameter larger than a diameter of the first and second pivot rod openings such that the pivot rod can only be removed in one direction, the edge portion pivot rod opening being in registry with the second pivot rod openings, the edge portion having a slot defined therein, the slot intersecting with the pivot rod opening; and,
a blocking member disposed in the slot and capable of moving between a first position and a second position, the blocking member extending into the edge portion pivot rod opening and obstructing the head of the pivot rod in the second position such that the pivot rod is prevented from exiting the edge portion pivot rod opening.

2. The belt module of claim 1, wherein the slot in the edge portion is disposed substantially parallel to the direction of belt travel.

3. The belt module of claim 1, wherein the blocking member has a detent member.

4. The belt module of claim 3, further comprising a detent opening extending to the slot.

5. The belt module of claim 4, wherein the detent member is disposed in the detent opening when the blocking member is in the first position.

6. The belt module of claim 1, wherein the blocking member has a first portion and a second portion, the second portion being wider than the first portion such that the blocking member has an L-shape.

7. The belt module of claim 1, wherein the blocking member has a slot defined therein.

8. The belt module of claim 3, wherein the detent member engages with a wall adjacent to the pivot rod opening when the blocking member is in the second position.

9. A modular belt, comprising:
a first belt module comprising a first plurality of link ends disposed in a direction of belt travel, the first link ends having first pivot rod openings disposed transverse to the direction of belt travel, a second plurality of link ends extending in a direction opposite to the first plurality of link ends, the second link ends being offset from the first link ends such that adjacently positioned belt modules are capable of intercalating so that the first link ends of one belt module fit into spaces defined between the second plurality of link ends of an adjacent belt module, the second link ends having second pivot rod openings disposed transverse to the direction of belt travel, an edge portion having an edge portion pivot rod opening disposed transverse to the direction of belt travel, the edge portion pivot rod opening having a diameter larger than a diameter of the first and second pivot rod openings of the first and second link ends, the edge portion pivot rod opening being in registry with the second pivot rod openings, the edge portion having a slot defined therein, the slot intersecting with the edge portion pivot rod opening, and a blocking member disposed in the slot and capable of moving between a first position and a second position, the blocking member extending into the edge portion pivot rod opening in the second position;
a second belt module disposed adjacent to the first belt module, the second belt module comprising a first plurality of link ends disposed in a direction of belt travel, the first link ends having first pivot rod openings disposed transverse to the direction of belt travel, a second plurality of link ends extending in a direction opposite to the first plurality of link ends, the second link ends being offset from the first link ends such that adjacently positioned belt modules are capable of intercalating so that the first link ends of one belt module fit into spaces defined between the second plurality of link ends of an adjacent belt module, the second link ends having second pivot rod openings disposed transverse to the direction of belt travel, an edge portion having an edge portion pivot rod opening disposed transverse to the direction of belt travel, the edge portion pivot rod opening having a diameter larger than a diameter of the first pivot rod openings of the first and second link ends, the edge portion pivot rod opening being in registry with the second pivot rod openings, the edge portion having a slot defined therein, the slot intersecting with the edge portion pivot rod opening, and a blocking member disposed in the slot and capable of moving between a first position and a second position, the blocking member extending into the edge portion pivot rod opening in the second position;
at least one pivot rod having an enlarged head at a first end, the at least one pivot rod disposed through the edge portion pivot rod opening in the first belt module and disposed through the intercalated first and second pivot rod openings of the first belt module and the second belt module, the enlarged head of the pivot rod being obstructed by the blocking member in its second position such that the pivot rod is prevented from exiting the edge portion pivot rod opening; and,
wherein the pivot rod can only be removed in one direction.

10. The belt module of claim 9, wherein the slot in the edge portion is disposed substantially parallel to the direction of belt travel.

11. The belt module of claim 9, wherein the blocking member has a detent member.

12. The belt module of claim 11, further comprising a detent opening extending to the slot.

13. The belt module of claim 12, wherein the detent member is disposed in the detent opening when the blocking member is in the first position.

14. The belt module of claim 9, wherein the blocking member has a first portion and a second portion, the second portion being wider than the first portion such that the blocking member has an L-shape.

15. The belt module of claim 9, wherein the blocking member has a slot defined therein.

16. The belt module of claim 11, wherein the detent member engages with a wall adjacent to the pivot rod opening when the blocking member is in the second position.

17. A method of configuring a modular belt, comprising: providing a plurality of belt modules having a first plurality of link ends disposed in a direction of belt travel, the first link ends having first pivot rod openings disposed transverse to the direction of belt travel, a second plurality of link ends extending in a direction opposite to the first plurality of link ends, the second link ends being offset from the first link ends such that adjacently positioned belt modules are capable of intercalating so that the first link ends of one belt module fit into spaces defined between the second plurality of link ends of an adjacent belt module, the second link ends having second pivot rod openings disposed transverse to the direction of belt travel, an edge portion having an edge portion pivot rod opening disposed transverse to the direction of belt travel, the edge portion pivot rod opening having a diameter larger than a diameter of the first and second pivot rod openings of the first and second link ends, the edge portion pivot rod opening being in registry with the second pivot rod openings, the edge portion having a slot defined therein, the slot intersecting with the edge portion pivot rod opening, a blocking member disposed in the slot and capable of moving between a first position and a second position, the blocking member extending into the pivot rod opening in the second position;
placing pivot rods through the pivot rod openings and the first and second pivot rod openings in adjacent belt modules such that the first and second link ends of the adjacent belt modules are intercalated and the adjacent belt modules are interlinked into adjacent hinged rows to form an endless belt capable of articulating about a drive sprocket; and,
wherein the pivot rods can only be removed from the intercalated modules in one direction.
